(19) United States
(12) Patent Application Publication
(10) Pub. No.: US 2014/0328735 A1
(43) Pub. Date: Nov. 6, 2014

(54) CONTAINER FOR THE LABORATORY AREA AND METHOD FOR MARKING SUCH A CONTAINER

(71) Applicant: Weidmann Plastics Technology AG, Rapperswil (CH)

(72) Inventors: John TINNER, Ibach (CH); Walter Albert, Ruti GL (CH); Karl Mazenauer, Jona (CH)

(73) Assignee: Weidmann Plastics Technology AG, Rapperswil (CH)

(21) Appl. No.: 13/973,571

(22) Filed: Aug. 22, 2013

(30) Foreign Application Priority Data
May 2, 2013 (CH) 0904/13

(51) Int. Cl. B01L 3/00; B23K 26/00

(52) U.S. Cl. CPC B01L 3/508; B23K 26/0066
USPC 422/554; 422/547; 422/561; 219/121.69

(57) ABSTRACT

Container (10, 10′) for the laboratory area, having: a body (1) with a layer (2) that is opaque to an optical reader, is applied to the body and has clearances (21) in the form of machine-readable data, the body (1) having at least one local material modification (3), and the material modification (3) together with the opaque layer (2) forming a reading area (6), in which the machine-readable data can be read from the outside by an optical reader on the basis of the optical contrast between the material modification (3) and the opaque layer (2).

### TECHNICAL FIELD

The present invention relates to a container for the laboratory area with a marking in the form of machine-readable data and to a method for marking such a container with machine-readable data.

### PRIOR ART

It is known to provide containers for the pharmaceutical laboratory area with machine-readable data or markings. The marking serves for the clear identification of a container and makes the assignment of container-specific information to a container possible.

In the pharmaceutical laboratory area, a large amount of containers of the most varied designs are required for investigating the content in them. The content of the containers differs in most cases, and consequently an individual marking of the containers is imperative. Since a multiplicity of identical containers are usually used at the same time, the automatic detection of the marking by an optical reader is of advantage. This allows a relatively great number of containers to be sensed in a shorter time and with greater reliability. The markings should therefore take the form of machine-readable data, such as for example matrix, dot or bar codes.

U.S. Pat. No. 6,372,293 discloses a cuvette with a machine-readable marking which is arranged on the surface and consists of an opaque multiple coating. A first layer is applied to the cuvette and covered by a second layer of a contrasting colour. Clearances in the form of machine-readable data are created in the second layer. The legibility is based on the colour contrast of the two layers.

A problem with such cuvettes is that damage to the outer layer can have the effect that the marking is illegible. Moreover, the production of the cuvette is complex and consequently involves high production costs, since two different layers are applied, it also having to be ensured that a clearance is only created in the second layer.

U.S. Pat. No. 6,270,728 discloses a transparent cuvette with an opaque carrier part, which has a machine-readable marking, fastened thereto, the marking being a burned-in dot coding. The legibility is based on the colour contrast of the carrier part and the burned-in marking.

A problem with such cuvettes is likewise that damage to the outer layer may have the effect that the marking is illegible.

### SUMMARY OF THE INVENTION

It is therefore an object of the present invention to provide a container for the laboratory area which is provided with machine-readable data, can be produced simply and inexpensively and in which the machine-readable data can be detected reliably and well by an optical reader. This object is achieved according to the invention by a container for the laboratory area such as that specified in Claim 1. Furthermore, two methods for marking a container for the laboratory area are specified in Claims 12 and 14. Further embodiments are specified in the dependent claims.

A container according to the invention for the laboratory area has a body, in particular a body formed in one piece, and a layer that is opaque to an optical reader, applied to the body, the opaque layer having clearances in the form of machine-readable data. The body has at least one local material modification, which together with the opaque layer forms a reading area. In the reading area, the machine-readable data can be read from the outside by an optical reader on the basis of the optical contrast between the material modification and the opaque layer.

The feature that the container is suitable for the laboratory area means that the container is suitable for at least one laboratory application. This application is for example a chemical application or a pharmaceutical application. The laboratory application is preferably in the pharmaceutical laboratory area, i.e. the development of active substances, or is preferably in the diagnostic laboratory area or is preferably a diagnostic application that takes place in the home area.

Machine-readable data are data that can be detected by an optical reader and preferably cannot readily be read by a person. The machine-readable data may in particular be a matrix, dot and/or bar code.

Providing the machine-readable data directly on or in the body has the effect of producing a reliable marking that cannot be removed from the body. The opaque layer applied to the body and provided with clearances has the effect of increasing the optical contrast with respect to the marking, which has the consequence that the marking can be detected better.

The body, in particular the one-piece body, may be produced from a single material or from a number of different materials. Different materials may be used in the form of mixtures. For example, a first material may be incorporated in a second material. It is also possible for a number of different materials to be incorporated in a further different material. For example, particles of one or more materials may be incorporated in a further different material.

Optical readers usually emit light of a specific wavelength and measure and evaluate the light reflected by the irradiated object. Optical readers may have a detection range from ultraviolet (100 to 380 nm) through infrared (780 nm to 400 μm) to the microwave range (400 μm to 25 cm) of the light spectrum. The range that is visible to the human eye lies at around 380 to 780 nm. If in this document something is described as transparent, semitransparent or opaque, this in each case refers substantially to the entire wavelength range of light (100 nm to 25 cm), preferably to the wavelength range of light that is visible for a person (380 to 780 nm).

According to a preferred embodiment, the body of the container has at least one cavity that can be filled with a material, such as for example a liquid or a solid. The container is therefore then formed for the most part, and in particular substantially, by the body, in particular by the one-piece body. The opaque layer is preferably arranged on a wall that bounds the cavity, the wall preferably forming at least one partial region of the outer side of the container. The container is preferably formed as a cuvette. However, any types of containers for the laboratory area are conceivable in principle, such as for example a container formed as a microtitre plate or as a cartridge. The microtitre plate preferably has as a component part at least one cuvette according to the invention, described within the scope of this patent. A cartridge should be understood for example as meaning a container that has a cavity for receiving a reagent, in particular a reaction reagent. The cuvette according to the invention may be formed differently, depending on its use. The cuvette may be formed for example in such a way that it can be used for keeping liquids and/or solids over a short or long time, or the cuvette may for example be formed in such a way that it can be used for carrying out optical measurements. The cuvette may for example also be formed as a reaction vessel. The body of the cuvette preferably has a bottom and a surrounding, closed side wall, which on its underside runs around the periphery of the bottom. The bottom and the side wall bound an upwardly open cavity of the cuvette. The bottom may be formed such that it is concave on its inner side and planar on its outer side. The body of the cuvette may have differing dimensions. For example, if the bottom surface of the body is of a rectangular or square form, the body has a width of 2 mm (millimetres) to 105 mm and a depth of 2 mm to 105 mm and a height of 0.5 mm to 80 mm. If the body comprises a bottom surface formed as a circular area, the circular area has for example a diameter of 0.8 mm to 15 mm. The height of the body that has a bottom surface formed as a circular area is for example 0.5 mm to 80 mm. The thickness of the side wall of the body is for example 0.5 to 2 mm, preferably 0.7 to 1.2 mm. The thickness of the bottom of the body is for example 0.3 to 2 mm, preferably 0.5 to 0.8 mm. The bottom surface of the body has for example an area of 4 mm² to 12 000 mm².

According to a preferred embodiment, the composition of the material from which the body is produced is different from the composition of the material from which the opaque layer is produced.

In another preferred embodiment, the container is a storing or transporting rack with a multiplicity of receiving positions, in particular for receiving containers that are smaller in comparison with the storing or transporting rack, such as for example cuvettes. The receiving positions have openings that are made to match the dimensions of the smaller containers to be arranged therein. Such a smaller container may have a marking in the form of machine-readable data that is of a type similar or identical to the marking or coding of the container according to the invention. This marking may have the information about the rack in which the smaller container is arranged. The marking may likewise have information concerning the position of the smaller container in the rack. The marking of the rack may have information concerning the number and position of the smaller containers received therein. In principle, the marking of the container according to the invention may have all the data that are relevant to the laboratory operation, such as for example the type, composition or amount of the content.

In a further preferred embodiment, the container is formed as a microtitre plate.

According to a preferred embodiment, the container has a bottom, the opaque layer outside the clearances forming at least partially, preferably completely, the bottom underside of the container. The bottom underside of the container that is formed by the opaque layer is preferably formed such that it is planar. The planar underside of the container bottom makes it possible in this case that the container can be placed onto a planar underlying surface.

According to a further preferred embodiment, the container has a bottom, the body forming at least partially, preferably completely, the bottom underside of the container. The bottom underside of the container that is formed by the body is preferably formed such that it is planar. The planar underside of the container bottom makes it possible in this case that the container can be placed onto a planar underlying surface.

According to a preferred embodiment, the container has a projection, which is preferably formed by the body, for placing the container on a setting-down area.

According to a preferred embodiment, the opaque layer is permanently attached to the body.

If the machine-readable data are provided on or in the bottom, i.e. in the region of the underside of the container, i.e. if for example the opaque layer or a protective layer arranged on the opaque layer forms at least partially the bottom underside of the container, the said data are easily accessible and can be detected well by an optical reading unit arranged underneath the container according to the invention, which is for example formed as a rack or as a cuvette or as a microtitre plate. As a result, the machine-readable data can be reliably read by the optical reader. The machine-readable data are in this case advantageously read from a direction approaching perpendicular. The arrangement of the machine-readable data on or in the bottom of the container also makes possible for example a transmission of light, such as for example through a side wall of the container, for analytical purposes.

The machine-readable data may also be arranged on or in a side wall of the container. It is also possible that the machine-readable data are arranged on or in a closure means of the container which closes a cavity of the container that can be filled with material.

According to a preferred embodiment, the container has at least one surrounding, closed side wall, which on its underside respectively runs around the periphery of a bottom, the at least one side wall and the respective bottom bounding at least one cavity, preferably at least one open cavity, more preferably an upwardly open cavity.

The reading area is formed by the opaque layer, arranged on the body, and the material modification, created on or in the body. The opaque layer usually has greater dimensions than the material modification. However, it is also possible that the material modification protrudes laterally beyond the opaque layer. The good legibility of the data is based on the optical contrast between the material modification and the opaque layer. The material modification and the opaque layer preferably have a light-dark contrast, such as for example a colour contrast, which is preferably a black-white contrast. Preferably, the material modification is dark and the opaque layer light. However, light material modifications with dark opaque layers are also possible. Preferably, the material modification is black and the opaque layer white. However, white material modifications with black opaque layers are also possible. The material modification is preferably opaque. This reduces the probability of material contained in the container, such as for example a liquid or a solid, being able to influence the optical reader. These preferred embodiments that are mentioned in this section produce particularly good legibility of the data by an optical reader.

According to a preferred embodiment, the material modification is created at least by a carbonization of the material of the body or at least by a foaming of the material of the body or by at least a modification, in particular a change of colour, of particles embedded in the material, such as for example pigments. The types of material modification mentioned produce particularly good contrast. The carbonization of the material is understood within the scope of this document as meaning a burning of the material. The carbonization is brought about for example by the introduction of thermal energy, or a supply of heat, into the material, such as for example by means of a laser. In the case of the foaming of the material, air is incorporated into the material.

According to a preferred embodiment, the material modification is arranged at least in the region of the clearances. More preferably, the material modification is arranged only in a region exposed by the clearances. A material modification arranged only in a region exposed by the clearances can be produced particularly easily, such as for example by means of a laser.

According to a preferred embodiment, the body is a permanent component part of the container. This means that the body is not detachable from the rest of the container. The body may, however, also be designed in such a way that it is detachable from the rest of the container and preferably can be reattached to the container.

Particularly preferably, at least the region of the body on which the opaque layer is arranged, in particular attached, such as for example at least a partial region of the bottom of the body and/or at least a partial region of the side wall of the body, is produced from plastic. This means that the at least one local material modification results from the modification of plastic. The use of plastic makes particularly inexpensive production of the container according to the invention possible. The body is preferably produced from plastic. This allows the container according to the invention to be produced particularly easily and inexpensively. The plastic is preferably a plastic that is transparent to an optical reader. In a further embodiment, the plastic is a plastic that is transparent to the human eye. Conventional transparent plastics are for example: polypropylene, polyethylene, polystyrene, polycarbonate or a cyclo-olefin copolymer, and acrylonitrile butadiene styrene. Containers with a body of transparent plastic have the advantage that for example the filling level or changes of material contained in the container can also be detected from the outside, through the body or container. Usually, the bodies such as those that have been described above and that form a component part of the container according to the invention are produced by the injection-moulding process.

According to a preferred embodiment, the body is formed in one piece. This allows the body, and consequently also the container, to be produced particularly easily and inexpensively.

In a preferred embodiment, the body is produced from a material that is opaque to the optical reader or opaque materials, such as for example a plastic. Material contained in the cavity of the container, such as for example a liquid or a solid, consequently cannot influence the optical reader. Opaque materials, in particular opaque plastics, are known to a person skilled in the art.

The opaque layer preferably comprises plastic or metal or ceramic or at least one coating layer or at least one film. The opaque layer preferably has a thickness of 1 micrometre to 5 millimetres, preferably a thickness of 1 micrometre to 2 millimetres. The opaque layer may be single-ply or multi-ply. In the case of a multi-ply form, the plies are preferably arranged one on top of the other. The opaque layer preferably comprises a single layer. A container according to the invention comprising a single layer can be produced particularly easily and inexpensively. An example of an opaque layer is the so-called hot stamping foil known to a person skilled in the art. Such a foil has for example a foil coloured with pigments and a bonding layer for attaching the coloured foil to the body. The hot stamping foil is applied to the body by the action of heat and pressure, the hot stamping foil thereby bonding with the body. Such hot stamping foils usually have thicknesses of 50 to 80 μm.

According to a preferred embodiment, the opaque layer is applied directly to the body. This embodiment can be produced particularly easily. The body and the opaque layer are advantageously produced altogether in one piece and in particular by the two-component injection-moulding process.

In a further preferred embodiment, a protective layer that is transparent to an optical reader is arranged on the opaque layer. This layer offers additional protection from external influences and therefore increases the reliability of the marking and the detectability of the machine-readable data. This transparent layer fills clearances that are present, in particular clearances that are present in the opaque layer, at least partially, preferably completely. The container preferably has a bottom, the transparent protective layer forming at least partially, preferably completely, the underside of this bottom of the container. The bottom surface of the container that is formed by the transparent protective layer is preferably formed such that it is planar. The planar surface of the container bottom makes it possible that the container can be placed onto a planar underlying surface.

In a further preferred embodiment, a bonding layer that is transparent to an optical reader is arranged between the body and the opaque layer. The transparent bonding layer preferably has an adhesive. The bonding layer may also be opaque. In this case, the clearances extend through the bonding layer.

In a preferred embodiment, the material modification is arranged on a surface of the body. The arrangement on the surface makes it possible for the material modification to be easily created and ensures good legibility. If the material modification is also arranged under the container surface, such as for example under the opaque layer at least partially forming the container surface, it is protected from external influences, which increases the reliability of the marking. According to a first variant, only the opaque layer is arranged on the material modification. In the case of this variant, the clearances extend through the opaque layer and protrude as far as the material modification(s). In the case of this first variant, the material of the body may be opaque or transparent. In the case of a second variant, the transparent intermediate layer on which the opaque layer is arranged is arranged on the material modification. According to a first possibility, the clearances extend only through the opaque layer. According to a second possibility, the clearances extend through the opaque layer and partially into the transparent layer. According to a third possibility, the clearances extend through the opaque layer and the transparent layer and consequently protrude as far as the material modification(s). In the case of this second variant, the material of the body may be opaque or transparent.

In a further preferred embodiment, the material modification is arranged within the body. The arrangement in the interior offers additional protection from external influences, which increases the reliability of the marking. According to a first variant, only the opaque layer is arranged on the body in the region of the material modification. According to a first possibility, the clearances extend only through the opaque layer. At least the material of the body between the material modification(s) and the surface of the body on which the opaque layer is arranged is then transparent. According to a second possibility, the clearances extend into the body. If the clearances do not extend as far as the material modification(s), at least the material of the body between the clearances and the material modification(s) is transparent. If the clearances extend as far as the material modification(s), the material of the body may be transparent or opaque. According to a second variant, the transparent intermediate layer on which the opaque layer is arranged is arranged on the body in the region of the material modification(s). According to a first possibility, the clearances extend only through the opaque layer. According to a second possibility, the clearances extend through the opaque layer and partially into the transparent layer. According to a third possibility, the clearances extend only through the opaque layer and the transparent layer. According to a fourth possibility, the clearances extend through the opaque layer and the intermediate layer and protrude into the material of the body, the clearances not extending as far as the material modification(s). In the case of the first, second, third and fourth possibilities mentioned, at least the material of the body between the clearances and the material modification(s) is then transparent, in order that the optical reader can detect the material modification. According to a fifth possibility, the clearances extend through the opaque layer and the intermediate layer and protrude as far as the material modification(s). In the case of this fifth possibility, the material of the body may be opaque or transparent.

In a preferred embodiment, the machine-readable data are formed at least partially, preferably completely, as a dot code. A dot coding can be produced particularly easily, such as for example by means of a laser.

According to a preferred embodiment, the distance at least between two neighbouring centre points of the clearances, which are preferably formed such that they are circular, in particular as a circular area, or square in cross section, in particular in the region of the externally visible surface of the opaque layer, is 0.4 millimetres or less, preferably 0.35 millimetres or less.

According to a preferred embodiment, the dimensions of the clearances, in particular in cross section, are 200 micrometres or less, preferably 175 micrometres or less, more preferably between 175 micrometres and 150 micrometres, still more preferably 150 micrometres or less. The clearances are preferably formed such that they are circular, in particular as a circular area, or square in cross section, in particular in the region of the externally visible surface of the opaque layer, and have a dimension of 200 micrometres or less, preferably 175 micrometres or less, more preferably between 175 micrometres and 150 micrometres, still more preferably 150 micrometres or less. If the clearance is formed as a circular area in cross section, the dimension is the diameter of the circular area. If the clearance is formed such that it is square in cross section, the dimension is the side length of the square.

The smaller the mentioned distance between the clearances is and the smaller the mentioned dimensions of the clearances are, the more information the reading area may have. Smallest possible distances and/or smallest possible dimensions are consequently preferred.

According to a preferred embodiment, the clearances are formed such that they are cylindrical or cuboidal, preferably as rectilinearly extending cylinders or cuboids. Cylindrical or cuboidal clearances, in particular rectilinearly extending cylinders or cuboids, can be produced particularly easily, such as for example by means of a laser.

A preferable method for marking a container for the laboratory area that is formed in particular as described above and has a body, in particular a body formed in one piece, with an opaque layer applied to it has at least the following steps in any desired sequence:
creating clearances in the form of machine-readable data in the opaque layer; and
creating at least one local material modification in or on the body, preferably at least in the region of the clearances.

The clearances and the material modification are in this case created in such a way that the opaque layer together with the material modification forms a reading area, in which the machine-readable data can be read from the outside by an optical reader on the basis of the optical contrast between the material modification and the opaque layer.

A further preferred method for marking a container for the laboratory area that is formed in particular as described above and has a body, in particular a body formed in one piece, with at least one local material modification has at least the following step:
providing a layer that is opaque to an optical reader with clearances in the form of machine-readable data on the body in such a way that the at least one material modification together with the opaque layer forms a reading area in which the machine-readable data can be read from the outside by an optical reader on the basis of the optical contrast between the material modification and the opaque layer.

In the case of these methods, the creation of the clearances in the opaque layer and/or the material modification of the body is/are preferably realized by chemical and/or physical processes. A chemical process is represented for example by etching. In the case of the physical processes, for example thermal energy is introduced locally into the body to be marked, such as for example by means of a laser, or the body is deformed locally, for example by the action of force, such as for example by a stamping. The material modification of the body usually has as a consequence a change in its optical properties (transmission, absorption, reflection).

In a preferred method, the creation of the clearances at least in the opaque layer and/or the material modification of the body is/are realized by a laser. The use of a laser has the effect that the at least one layer bounding the clearances, which clearances are arranged for example in the opaque layer and optionally in the body and/or in the protective layer, is substantially not frayed, or the clearances have sharp contours. This allows good and reliable legibility of the machine-readable data by an optical reader. Usually, Nd:YAG lasers or CO₂ lasers or excimer lasers are used. Preferably, Nd:YAG lasers are used. The laser brings about a local heating of the material and thus brings about a material modification. In the case of a material modification on the surface of the body, the laser beam heats up the surface when it impinges on it, and for example brings about a structural change of the material, such as for example by a carbonization of the material or by a foaming of the material. In the case of carbonization, the modified material has a different colour and/or lightness in comparison with the material of the body before the modification thereof. The modified material is usually darker in comparison with the material before the modification thereof, or in comparison with the starting material. In the case of foaming, the modified material likewise has a different colour and/or lightness in comparison with the starting material of the body. The modified material is usually lighter. In the case of a material modification in the interior of the body, a heating up of the material is achieved by the laser, for example by the focusing of a laser beam or by two crossing laser beams or by the heating up of incorporated particles. If the material in the interior heats up directly or on account of the heated particles, this may have the consequence of both carbonization and foaming. In a further method, incorporated particles, for example pigments, are heated by the action of a laser beam and, as a consequence of this, change their colour. The incorporated particles may be uniformly distributed in the body as a whole or may be present more in certain regions, for example layers, such as for example in outer layers.

A carbonization or foaming of the material, and the changing of the colour of pigments, are of course also possible by other methods known to a person skilled in the art than by means of a laser.

### BRIEF DESCRIPTION OF THE DRAWINGS

Preferred embodiments of the invention are described below on the basis of the drawings, which merely serve for the purpose of explanation and are not to be interpreted as restrictive. In the drawings:

FIG. 1 schematically shows a perspective representation of a container according to the invention with a coded bottom;

FIG. 2 schematically shows a central sectional view of the lower region of a cuvette-like body, which is a component part of the container formed as a cuvette according to FIG. 1;

FIG. 3 schematically shows a central sectional view of the lower region of a first embodiment of a container according to the invention;

FIG. 4 schematically shows a central sectional view of the lower region of a second embodiment of a container according to the invention;

FIG. 5 schematically shows a central sectional view of the lower region of a third embodiment of a container according to the invention;

FIG. 6 schematically shows a central sectional view of the lower region of a fourth embodiment of a container according to the invention;

FIG. 7 schematically shows a central sectional view of the lower region of a fifth embodiment of a container according to the invention;

FIG. 8 schematically shows a central sectional view of the lower region of a sixth embodiment of a container according to the invention;

FIG. 9 schematically shows a central sectional view of the lower region of a seventh embodiment of a container according to the invention;

FIG. 10 schematically shows a central sectional view of the lower region of an eighth embodiment of a container according to the invention;

FIG. 11a schematically shows a perspective representation of the upper side of a ninth embodiment of a container according to the invention, which is formed as a storing or transporting rack for receiving cuvettes;

FIG. 11b schematically shows a perspective representation of the underside of the container according to the invention according to FIG. 11a;

FIGS. 12a-12c schematically show method steps for producing a tenth embodiment of a container according to the invention;

FIG. 12d schematically shows a central sectional view of the lower region of an eleventh embodiment of a container according to the invention; and

FIGS. 13a and 13b schematically show method steps for producing a container according to the invention.

### DESCRIPTION OF PREFERRED EMBODIMENTS

In the embodiments described below, features that are the same, similar or act in a similar way are respectively provided with the same designations.

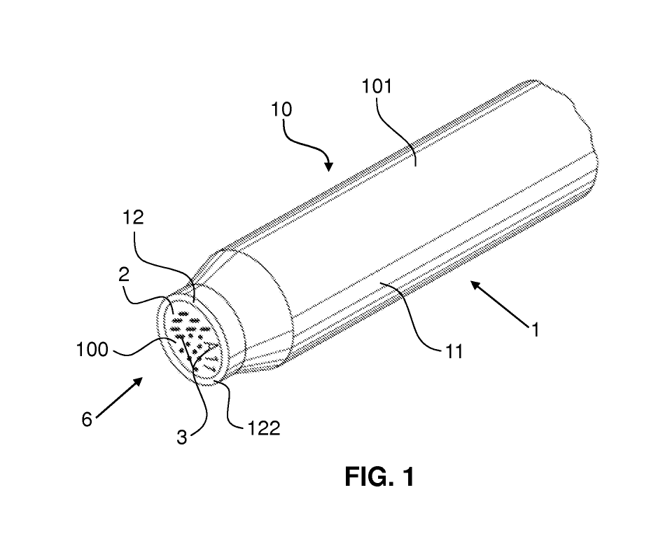

FIG. 1 schematically shows a container 10 according to the invention in the form of a cuvette, comprising a body 1 formed in one piece and an opaque layer 2. The body 1 comprises a body bottom 12 with a bottom surface 122. In the case of the container 10 that is represented in FIG. 1, the opaque layer 2 is arranged on the bottom surface 122, so that the opaque layer 2 forms the bottom surface or underside 100 of the container 10. The container 10 has a reading area 6, which is provided with machine-readable data that can be read from outside by an optical reader. The reading area 6 has the layer 2 that is opaque to the optical reader and material modifications 3 that are created in the body 1, the legibility of the machine-readable data or the marking being provided by the optical contrast between the opaque layer 2 and the material modifications 3. The reading area 6 is defined by the opaque layer 2 and the material modifications 3. The marking or the machine-readable data serve for example for the clear identification of individual containers. In principle, the machine-readable data may be arranged at any desired location on an outer side 101 of the container 10 and/or on an inner side of the container 10, such as for example on and/or in a side wall 11. This container 10, formed as a cuvette, may be used for example for keeping liquids and/or solids over a short or long time.

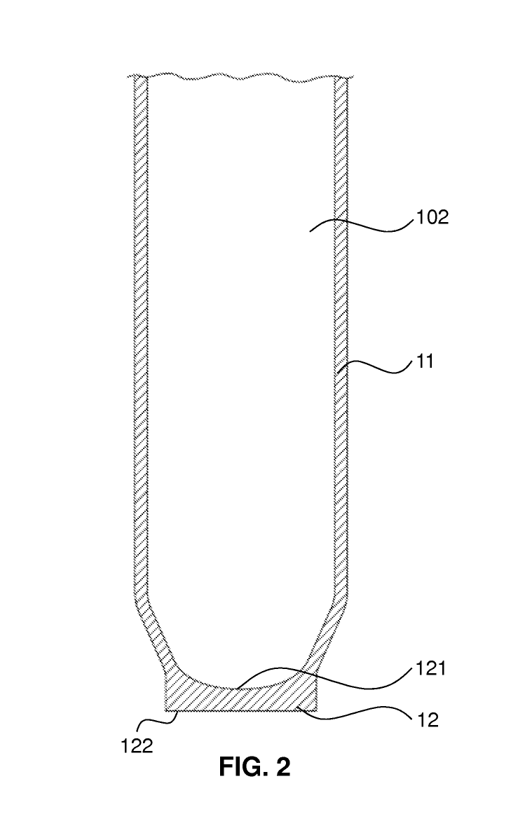

FIG. 2 schematically shows a lateral, central sectional view of a one-piece body 1 in the form of a cuvette, which for example, as represented in FIG. 1, forms the body 1 of the container 10 according to the invention. The body 1 in the form of a cuvette has no machine-readable coding. The body 1 formed in one piece in the form of a cuvette has a surrounding side wall 11, which runs around the periphery of a bottom 12, the side wall 11 together with the bottom 12 defining an upwardly open cavity 102. The body 1 in the form of a cuvette has a concave bottom inner side 121 and, on the outer side, a planar surface 122.

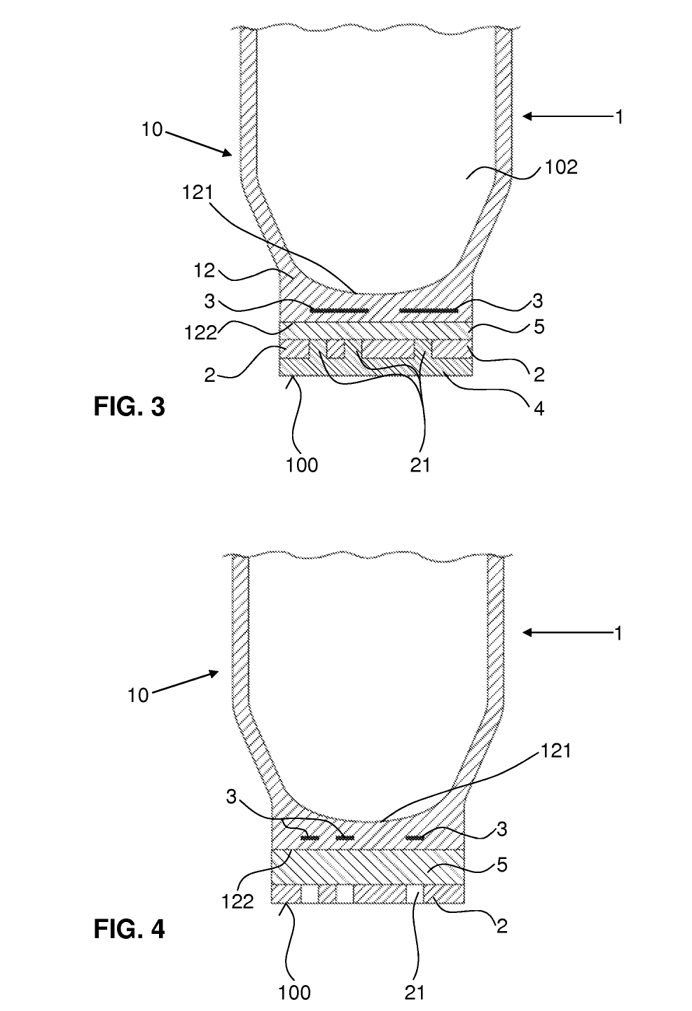

FIG. 3 schematically shows a lateral, central sectional view of the lower region of a first embodiment of a container 10 according to the invention, which is formed as a cuvette and has an indicated, upwardly open cavity 102. The cuvette has the body 1 in the form of a cuvette, which is formed in a way corresponding to that shown in FIG. 2. In the bottom 12 of the body 1 there are local material modifications 3, which in the case of this embodiment are in the interior of the body 1. On the bottom surface 122 of the body 1, an opaque layer 2 is provided by means of a transparent bonding layer 5, such as for example an adhesive. The bonding layer 5 covers the entire bottom surface 122 of the body 1. The opaque layer 2 has in the region of the material modifications 3 clearances 21, through which the material modifications 3 can be seen from the outside. In the case of the embodiment represented here, the material modifications 3 are not only present in the region exposed by the clearances 21, but protrude laterally beyond them. Arranged on the opaque layer 2 and in the clearances 21 is a transparent protective layer 4. This protective layer 4 is not absolutely necessary, but increases the wear resistance and thus contributes to increasing the reliability of the marking or of the machine-readable data. Consequently, in the case of the embodiment according to FIG. 3, the protective layer 4 forms the bottom surface or underside 100 of the container 10. The material of the body 1 is transparent, in order that the material modifications 3 can be detected by the optical reader.

FIG. 4 schematically shows a lateral, central sectional view of the lower region of a second embodiment of a container 10 according to the invention, which is formed as a cuvette. As a difference from the first embodiment, the transparent bonding layer 5 is made thicker. The material modifications 3 are only present in the region of the clearances 21. An additional protective layer is not present. In the case of this embodiment, the opaque layer 2 forms the bottom surface or underside 100 of the container 10. The material of the body 1 is in turn transparent, in order that the material modifications 3 can be detected by the optical reader.

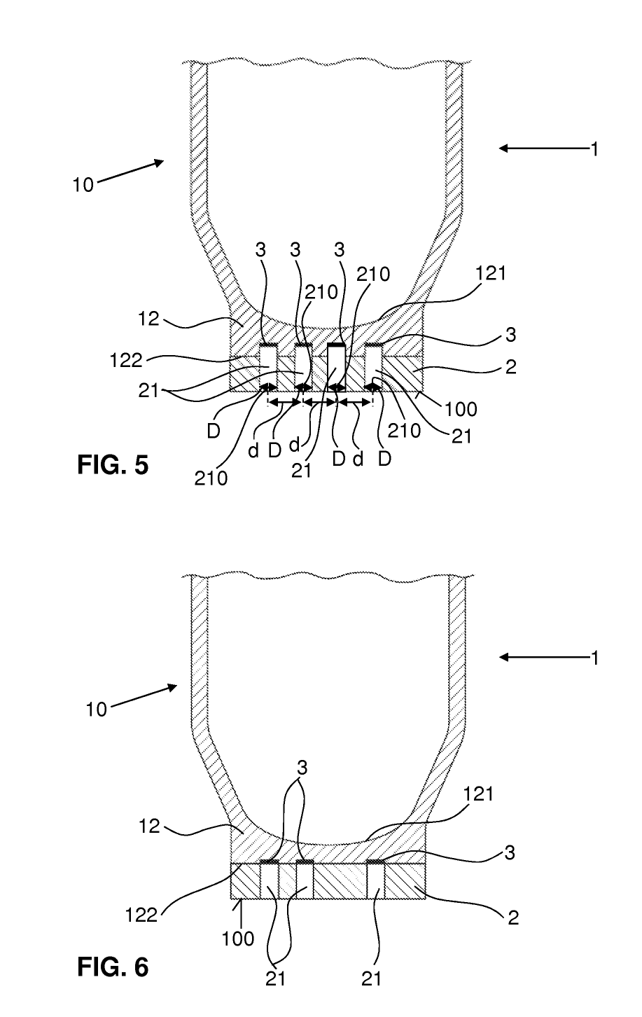

FIG. 5 schematically shows a lateral, central sectional view of the lower region of a third embodiment of a container 10 according to the invention, which is formed as a cuvette. The body 1 has in the bottom 12 local material modifications 3, which in this embodiment are located on the surface of the body 1, but recessed in the bottom 12. On the bottom surface 122 of the body 1, an opaque layer 2 is arranged directly on it. The opaque layer 2 has in the region of the material modifications 3 clearances 21, which are formed as rectilinearly extending cylinders and through which the material modifications 3 can be seen from the outside. In the case of the embodiment according to FIG. 5, the material of the body 1 may be transparent or opaque, since the clearances 21 extend as far as the material modifications 3.

The clearances 21 are formed as a circular area in cross section in the region of the surface of the opaque layer 2 that forms the bottom surface 100 of the container 10 and have a diameter D of 175 micrometres. The distance d between the centre points 210 of the clearances 21 formed as a circular area in cross section in the region of the surface of the opaque layer 2 is 0.35 mm. As can be seen in FIG. 5, the machine-readable data are formed as dot coding. In the case of the embodiment represented here, the material modifications 3 are present only in the region exposed by the clearances 21. The clearances 21 continue in the body bottom 12 and protrude into it as far as the material modifications 3. The clearances 21 and the material modifications 3 are preferably created by a laser, it being possible in particular for the material modifications 3 to be produced by a carbonization of the body 1. In the case of this embodiment according to FIG. 5, the opaque layer 2 forms the bottom surface 100 of the container 10. It is known in principle to a person skilled in the art how local material modifications can be created in the case of the material of the body 1, such as for example by carbonization or foaming, in particular by the use of a laser or else other means known to a person skilled in the art, and which materials can be used here for the body 1. It is similarly known to a person skilled in the art how clearances can be created in the opaque layer 2, in particular by the use of a laser or other means known to a person skilled in the art, and which materials can be used for the opaque layer 2.

FIG. 6 schematically shows a lateral, central sectional view of the lower region of a fourth embodiment of a container 10 according to the invention, which is formed as a cuvette. As a difference from the third embodiment, the material modifications 3 are located on the surface of the body 1 in such a way that, even in the region of the material modifications 3, the body 1 altogether forms a substantially planar bottom surface 122 or underside 122 of the body 1. The clearances 21 of the opaque layer 2 do not continue in the bottom 12 of the body 1. In the case of this embodiment, the opaque layer 2 forms the bottom or the bottom surface 100 of the container 10. Since the material modifications 3 are arranged on the surface of the body, the material of the body 1 may be transparent or opaque.

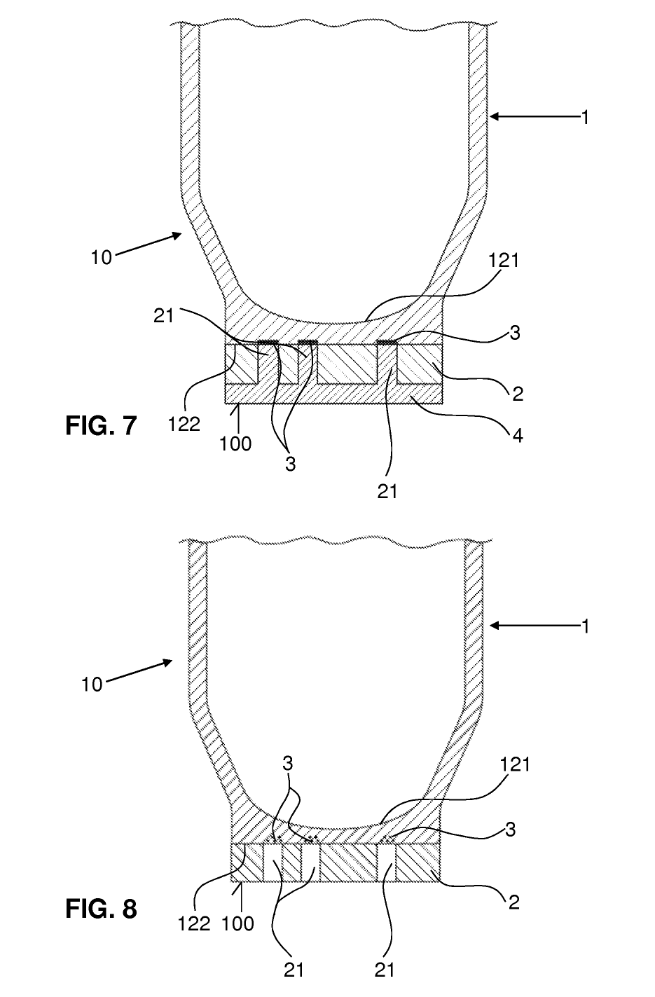

FIG. 7 schematically shows a lateral, central sectional view of the lower region of a fifth embodiment of a container 10 according to the invention, which is formed as a cuvette, this being the fourth embodiment with an additional protective layer 4 arranged on the opaque layer 2, and the protective layer 4 extending completely into the clearances 21 of the opaque layer 2. In the case of this embodiment, the protective layer 4 consequently forms the bottom surface 100 of the container 10. By analogy with the embodiment according to FIG. 6, the material of the body 1 may be transparent or opaque.

FIG. 8 schematically shows a lateral, central sectional view of the lower region of a sixth embodiment of a container 10 according to the invention, which is formed as a cuvette. As a difference from the embodiment represented in FIG. 6, in this embodiment the material modifications 3 represent a change in colour of particles embedded in the body 1, the particles being pigments for example, and it being possible for the change in colour to be brought about for example by the irradiation of the particles with a laser beam. In the case of this embodiment, the opaque layer 2 forms the bottom surface 100 of the container 10. The material of the body 1 is transparent, in order that the optical reader can detect the material modifications 3.

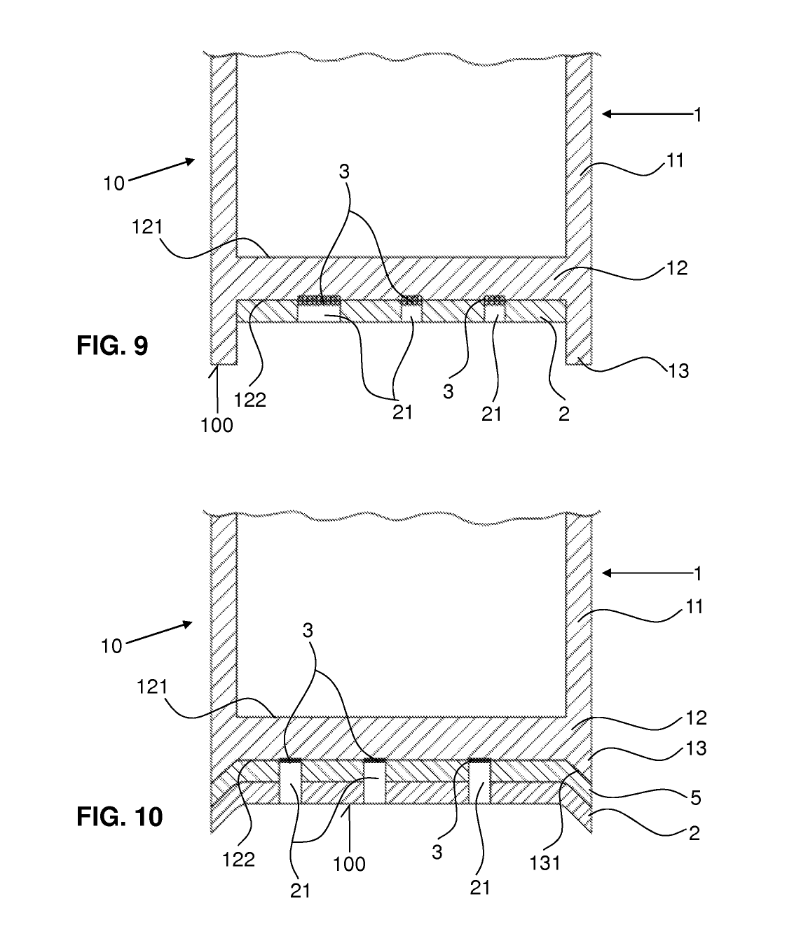

FIG. 9 schematically shows a lateral sectional view of the lower region of a seventh embodiment of a container 10 according to the invention, which is formed as a cuvette and has a body 1, on the bottom 12 of which a projection 13 is formed in one piece with it and projects in a direction substantially perpendicular to the bottom surface 122 of the body 1. The projection 13 extends substantially as an extension of the surrounding side wall 11 of the cuvette and may be of a closed, surrounding form or be provided with interruptions. In this embodiment, the transition between the bottom surface 122 of the body 1 and the projection 13 is sharp-edged, i.e. the projection 13 stands substantially perpendicularly on the bottom surface 122. The opaque layer 2 is arranged on the bottom surface 122 and, outside the clearances 21, extends substantially over the entire surface 122. The projection 13 runs around the periphery of the opaque layer 2 and projects from it, so that when the cuvette is placed on a setting-down area, the opaque layer 2 does not come into contact with this setting-down area. In the case of this embodiment, the body 1 consequently forms at least part of the bottom surface 100 of the container 10 and thereby in particular that part of the bottom surface 100 with which the container 10 can be placed on a setting-down area. A transparent protective layer is not necessary in the case of this embodiment, but may nevertheless be applied to increase the reliability further. The clearances 21 are created here by the action of a laser beam, the material modifications 3 in the case of this embodiment preferably being achieved by the foaming of the body 1 on its bottom surface 122. The foaming is preferably realized by means of a laser beam. The material of the body 1 may be opaque or transparent.

FIG. 10 schematically shows a lateral sectional view of the lower region of an eighth embodiment of a container 10 according to the invention, which is formed as a cuvette and has a one-piece body 1 with a bottom 12. A projection 13 is formed in one piece with the bottom 12, projects from it in a substantially perpendicular direction in relation to the bottom surface 122 and extends substantially as an extension of the surrounding side wall 11 of the cuvette, it being possible for the projection to be of a closed, surrounding form or be provided with interruptions. The inner side area 131 of the projection 13 is arranged at an angle of 45 to 75° with respect to the perpendicular to the bottom surface 122. The opaque layer 2 is arranged continuously on the bottom surface 122, which comprises the inner side area 131 of the projection 13, by means of a transparent bonding layer 5. The clearances 21 are preferably created by the action of a laser beam, the material modifications 3 in the case of this embodiment being achieved by the carbonizing of the body 1 on its bottom surface 122, or by the carbonization of the material of the body 1 that forms the bottom surface 122 of the body 1. The carbonizing is preferably realized by means of a laser beam. In the case of this embodiment, as can be seen in FIG. 10, the opaque layer 2 forms the bottom surface 100 of the container 10. The material of the body 1 may be transparent or opaque.

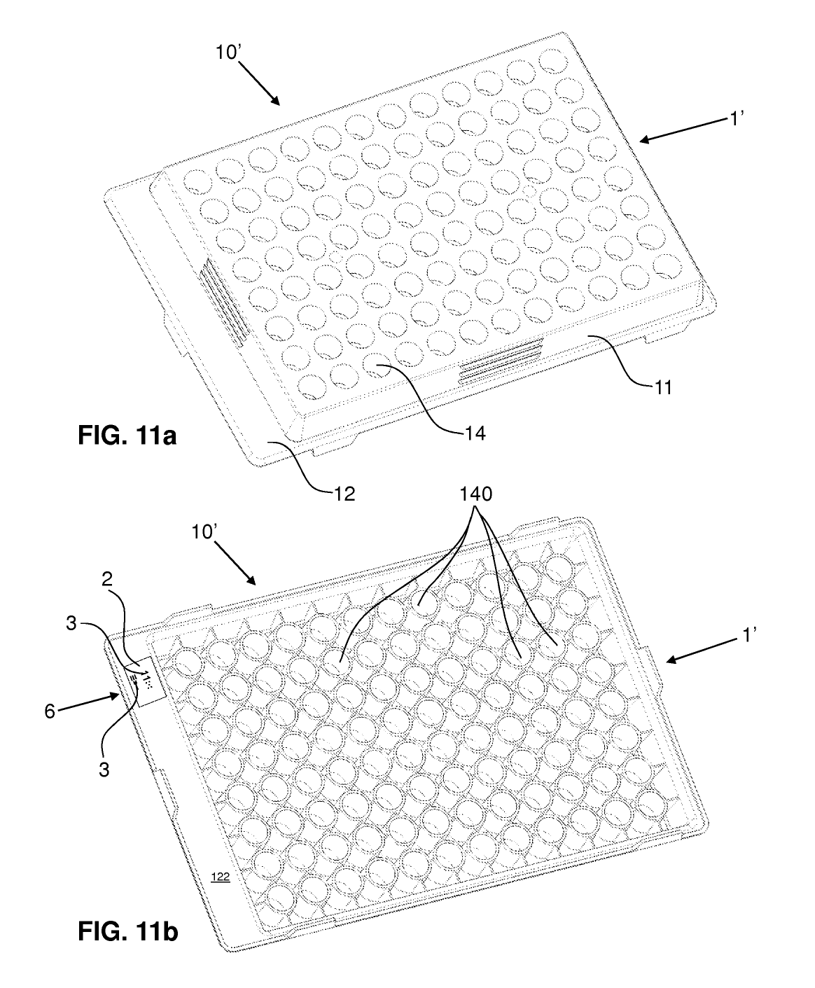

FIGS. 11a and 11b show perspective representations of a container 10′ according to the invention, which is formed as a storing or transporting rack for receiving cuvettes, FIG. 11a showing the upper side and FIG. 11b showing the underside of the container 10′. The container 10′ has a closed, surrounding periphery 11 and a bottom 12, as well as a number of receiving positions 14 for receiving cuvettes. The container 10′ has a body 1′ in the form of a storing or transporting rack with a bottom surface 122. This body 1′ in the form of a storing or transporting rack corresponds to a prior-art storing or transporting rack without machine-readable coding. The container 10′ has a reading area 6, which is provided with machine-readable data that can be read from the outside by an optical reader. The reading area 6 has the layer 2 that is opaque to the optical reader and material modifications 3 that are created in the body 1′, the legibility of the machine-readable data or the marking being provided by the optical contrast between the opaque layer 2 and the material modifications 3. If a covering that is not represented and is partially liquid-permeable if the covering is formed as a filter, for example, or is liquid-impermeable is arranged on an opening 140 of at least one receiving position 14 arranged on the underside of the storing or transporting rack 10′ according to FIGS. 11a and 11b, this change to the structural design of the storing or transporting rack results in a microtitre plate according to the invention. This microtitre plate is of course only given by way of example and a large number of variations are possible.

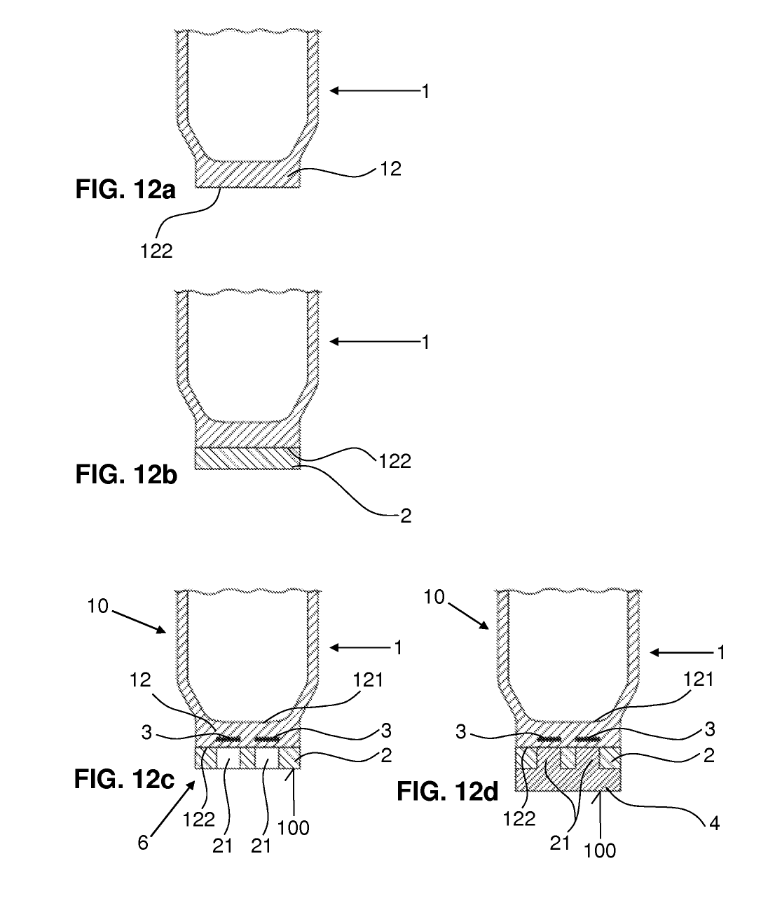

FIGS. 12a to 12d schematically show the method steps for producing a container 10 according to the invention, which is formed as a cuvette. FIG. 12a shows a body 1 in the form of a cuvette, which has a bottom 12 with a bottom surface 122 and will form the body 1 of the produced container 10 according to the invention according to FIGS. 12c and 12d. This is produced by means of a conventional plastics injection-moulding process.

After the production of the body 1 in the form of a cuvette according to FIG. 12a, an opaque layer 2 is arranged on its bottom surface 122 (FIG. 12b). The opaque layer 2 may be provided on the bottom surface 122 directly or by means of a transparent bonding layer 5, such as for example an adhesive. Conventional processes may be used for providing the opaque layer 2, such as the application of a hot stamping foil, printing by means of pad printing or offset printing, spraying or moulding on. An example of a moulding-on process is the two-component injection-moulding process, by means of which the body 1 in the form of a cuvette is first produced and then the opaque layer 2, or by means of which the opaque layer 2 is first produced and only then the body 1 in the form of a cuvette. A further example of a moulding-on process is that known to a person skilled in the art as in-mould labelling (IML), in which polymer is injected as a backing onto a film that is placed into a cavity and forms the opaque layer 2 of the container 10 according to the invention to be produced. The polymer that is injected as a backing onto the film forms the body 1 in the form of a cuvette. The thickness of the opaque layer 2 is usually 1 μm to 5 mm, preferably 1 μm to 2 mm.

As represented in FIG. 12c, clearances 21 in the form of machine-readable data are created in the opaque layer 2 attached to the body 1 in the form of a cuvette and material modifications 3 are created in the body 1 in the form of a cuvette, and in this way the container 10 according to the invention is produced according to a ninth embodiment, which is formed as a cuvette. Preferably, a clearance 21 is created by the action of a laser beam and preferably the exposed region of the bottom 12 of the body 1 in the form of a cuvette is subsequently subjected to a material modification 3, such as for example by means of a laser. In FIG. 12c, two material modifications 3 which are arranged next to one another and have been produced by carbonization of the material forming the bottom 12 by means of a laser are represented by way of example in the bottom 12 of the body 1. After this method step, in the case of this embodiment the opaque layer 2 forms the bottom surface 100 of the container 10.

In a further method step, a transparent protective layer 4 is arranged in the reading area 6, that is in the region of the material modifications 3 and the clearances 21 of the container 10, and in this way the tenth embodiment of a container 10 according to the invention is produced according to FIG. 12d. As can be seen in FIG. 12d, in the case of this embodiment the protective layer 4 forms the bottom surface 100 of the container 10.

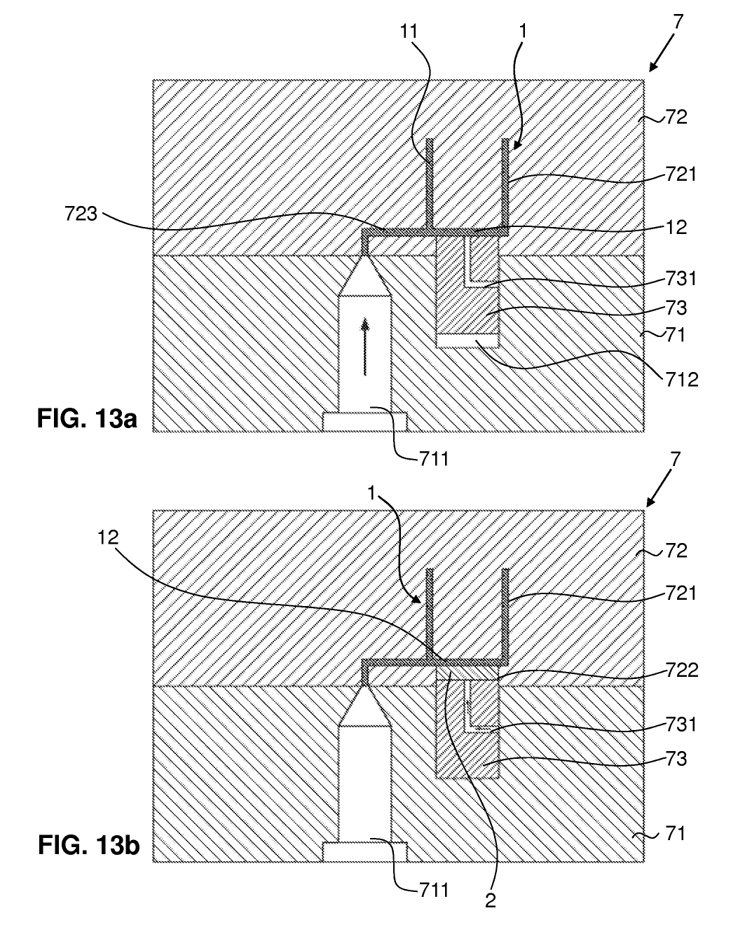

FIGS. 13a and 13b schematically show two method steps of a production method for producing a container according to the invention in the form of a cuvette, the two method steps concerning a plastics injection-moulding process. Plastics injection-moulding processes, in particular the two-component injection-moulding process shown on the basis of FIGS. 13a and 13b, are known to a person skilled in the art. In a first method step, the body 1 in the form of a cuvette of the container according to the invention to be produced, which is formed as a cuvette, is produced, as explained in the following text: the injection-moulding machine 7 according to FIG. 13a has a mould outer part 71 with a first polymer feed 711, a mould core 72 with a cavity 721 and a feed channel 723, and a mould insert 73 with a second, only indicated polymer feed 731. The cavity 721 has the form of the body 1 in the form of a cuvette of the container to be produced with a surrounding side wall 11 and an integrated bottom 12. The mould outer part 71 and the mould core 72 are aligned in relation to each other such that the first polymer feed 711 is in connection with the cavity 721 via the feed channel 723. The mould insert 73 is in a first position, in which it is arranged in the mould outer part 71 and extends into the mould core 72, bounds the cavity 721 and closes it off from the outside. The mould insert 73 is arranged displaceably in the mould outer part 71. Opposite from the bounding surface with respect to the cavity 721 and in the mould outer part 71 there is adjacent to the mould insert 73 a free space 712, which allows the displacement of the mould insert 73 in the direction of the mould outer part 71 into a second position.

Polymer is then injected into the cavity 721 via the first polymer feed 711 and the feed channel 723, so that the cavity is filled with polymer, as is represented in FIG. 13a, and the body 1 in the form of a cuvette is thereby formed.

In a second method step, the mould insert 73 is then displaced into a second position, as represented in FIG. 13b, so that said insert is in a position remote from the cavity 721 and thus exposes the additional cavity 722 adjacent to the cavity 721 at the bottom 12, which additional cavity is then filled with polymer, as represented in FIG. 13b, via the only indicated, second polymer feed 731, and thus the opaque layer 2 is formed on the bottom of the body 1 in the form of a cuvette. Preferably, the polymer which is injected into the additional cavity 722 has a different composition than that which is injected into the cavity 721. Preferably, the polymer in the cavity 721 is transparent and that in the additional cavity 722 is opaque. Then, in a further step that is not represented, the body 1 thus produced, on the bottom 12 of which an opaque layer 2 is arranged, is demoulded from the mould outer part 71 and the mould core 72 and, in a next step that is not represented, is provided with at least one material modification and at least one clearance, as already described, and the container according to the invention, which is formed as a cuvette, is thereby created.

The invention described here is of course not restricted to the embodiments mentioned and a large number of variations are possible. For example, the body does not necessarily have to have a bottom and a surrounding side wall for bounding a cavity that can be filled, but may for example also be formed as a simple carrier part that is attached to any desired prior-art container, and in particular to a conventional cuvette, such as that shown in FIG. 2. The clearances 21 represented in FIGS. 3, 4, 8, 12c and 12d may for example likewise extend as far as the material modifications 3, as described on the basis of FIG. 5. Of course, the clearances 21 of the container 10 according to FIG. 5 do not have to be respectively formed as a circular area in cross section, but may also be designed differently, such as for example such that they are square. By analogy, the clearances 21 of the container 10 according to FIGS. 3, 4, 6, 7, 8, 9, 10, 12c and 12d may for example be designed in the form of a circular area, in particular as a circular area, or such that they are square. Moreover, the coding of the container 10 according to FIG. 5 does not necessarily have to be formed as dot coding, but may also be differently formed. Of course, the diameter D and/or the distance d in the case of the embodiment according to FIG. 5 may also be chosen differently than that described. The containers 10 represented in FIGS. 1 to 10, 12c and 12d, in particular their bodies 1, and the container 10′ according to FIGS. 11a and 11b, in particular their bodies 1′, are represented by way of example and may also be differently formed. Thus, for example, the concave bottom inner side 121 of the bodies 1, or of the containers 10, according to FIGS. 3 to 8, 12c and 12d does not necessarily have to be concave and may also be differently designed, such as for example the bottom inner side 121 of the bodies 1, or of the containers 10, according to FIGS. 9 and 10. Similarly, the bottom surface 122 of the bodies 1, or the bottom surface 100 of the containers 10, as shown in FIGS. 1 to 10, 12c and 12d does not necessarily have to be planar, but may also be differently formed. Of course, the containers 10 according to FIGS. 3, 7 and 12d do not necessarily have to have a protective layer 4, but may also have no protective layer 4. Of course, a protective layer 4 may be arranged on the opaque layer 2 of the containers 10 according to FIGS. 1, 4, 5, 6, 8, 9 and 10. The bodies 1 of the containers 10 according to FIGS. 1 to 10, 12c and 12d as well as the body 1′ of the container 10′ may in addition to or instead of the material modifications 3 lying next to one another also have material modifications 3 that lie one above the other. Moreover, by analogy with the containers 10 as shown in FIGS. 3, 4 and 10, the containers 10 according to FIGS. 5, 6, 7, 8, 9, 12c and 12d may also have an intermediate layer 5. In the case of the containers 10 according to FIGS. 3 and 4, it is also possible that the clearances 21 extend through the intermediate layer 5 and optionally continue in the cuvette bottom 12 and protrude as far as the material modifications 3. In the case of the containers 10 according to FIGS. 5, 6, 7, 8, 10, 12c and 12d, the opaque layer 2 outside the clearances 21 does not necessarily have to be arranged on the entire bottom surface 122 of the body 1, but may, as disclosed in FIG. 1, for example also be arranged outside the clearances 21 only partially on the bottom surface 122 of the body 1. In the case of the containers 10 according to FIGS. 1, 3, 4, 5, 6, 7, 8, 10, 12c and 12d, it is of course possible, by analogy with the container 10 according to FIG. 9, for that part of the bottom surface 100 of the container 10 on which the container 10 can be placed onto a setting-down area also to be formed by a projection 13 of the body 1, instead of by the opaque layer 2 or the protective layer 4. The various elements of the embodiments shown in FIGS. 1 to 10, 12c and 12d may also be combined with one another as desired. A large number of variations are conceivable. Also in the case of the embodiment of the container according to the invention according to FIGS. 11a and 11b, or in the case of the microtitre plate described on the basis of FIGS. 11a and 11b, a large number of variations are conceivable.

LIST OF DESIGNATIONS

| | | | |
|---|---|---|---|
| 1, 1′ | body | 3 | material |
| 10, 10′ | container | | modification |
| 100 | bottom surface of | 4 | protective layer |
| | the container | 5 | bonding layer |
| 101 | outer side | 6 | reading area |
| 102 | cavity | 7 | injection-moulding |
| 11 | side wall | | machine |
| 12 | bottom of the body | 71 | mould outer part |
| 121 | bottom inner side | 711 | first polymer feed |
| 122 | bottom surface of | 712 | free space |
| | the body | 72 | mould core |
| 13 | projection | 721 | cavity |
| 131 | inner side area | 722 | additional cavity |
| 14 | receiving position | 723 | feed channel |
| 140 | opening | 73 | mould insert |
| 2 | opaque layer | 731 | second polymer feed |
| 21 | clearances | d | distance |
| 210 | centre point | D | diameter |

1. Container for the laboratory area, having a body and a layer that is opaque to an optical reader, is applied to the body and has clearances in the form of machine-readable data, the body having at least one local material modification, and the material modification together with the opaque layer forming a reading area, in which the machine-readable data can be read from the outside by an optical reader on the basis of the optical contrast between the material modification and the opaque layer.

2. Container according to claim 1, the container being a cuvette.

3. Container according to claim 1, the container being a storing or transporting rack with a multiplicity of receiving positions, in particular for receiving cuvettes, or a microtitre plate.

4. Container according to claim 1, the body forming at least partially, in particular substantially, the bottom of the container.

5. Container according to claim 4, the body also forming a surrounding side wall, extending from the bottom, and the bottom and the side wall together bounding a cavity that can be filled of the container.

6. Container according to claim 1, the material modification being arranged on a surface of the body.

7. Container according to claim 1, the material modification being arranged within the body.

8. Container according to claim 1, the body being produced from a material that is transparent or semi-transparent to an optical reader.

9. Container according to claim 1, the body being produced from a material that is opaque to the optical reader.

10. Container according to claim 1, a protective layer that is transparent or semi-transparent to an optical reader being arranged on the opaque layer.

11. Container according to claim 1, a bonding layer that is transparent or semi-transparent to an optical reader being arranged between the body and the opaque layer.

12. Method for marking a container for the laboratory area, which has a body with an opaque layer applied to it, having at least the following steps in any desired sequence:
creating clearances the form of machine-readable data in the opaque layer; and
creating at least one local material modification in or on the body,
the clearances and the material modification being created in such a way that the opaque layer together with the material modification forms a reading area, in which the machine-readable data can be read from the outside by an optical reader on the basis of the optical contrast between the material modification and the opaque layer.

13. Method according to claim 12, the creation of the clearances in the opaque layer and/or the material modification of the body being realized by a chemical or physical process, in particular by means of a laser.

14. Method for marking a container for the laboratory area, which has a body with at least one local material modification, having at least the following step:
providing a layer that is opaque to an optical reader with clearances in the form of machine-readable data on the body in such a way that the at least one material modification together with the opaque layer forms a reading area in which the machine-readable data can be read from the outside by an optical reader on the basis of the optical contrast between the material modification and the opaque layer.

15. Method according to claim 14, an opaque layer first being applied to the body, in which layer the clearances are then created, in particular by a chemical or physical process, and preferably by means of a laser.
